(19) United States
(12) Patent Application Publication
(10) Pub. No.: US 2026/0340920 A1
(43) Pub. Date: Oct. 29, 2026

(54) TRANSFORMING IMAGE TO A DUAL-STYLIZED AVATAR

(71) Applicant: Snap Inc., Santa Monica, CA (US)

(72) Inventors: Eric Ming Chen, Cambridge, MA (US); Jian Wang, West New York, NJ (US); Sizhou Ma, Long Island City, NY (US); Mikhail Vasilkovskii, Playa Vista, CA (US); Bing Zhou, Rye, NY (US); Qiang Gao, San Diego, CA (US); Wenzhou Wang, New York, NY (US)

(21) Appl. No.: 19/191,784

(22) Filed: Apr. 28, 2025

(51) Int. Cl. G06T 13/40; G06T 15/02; G06T 19/00; G06V 10/82

(52) U.S. Cl. CPC G06T 13/40; G06T 15/02; G06T 19/006; G06V 10/82

(57) ABSTRACT

A system for generating a dual-stylized 3D avatar is provided. The system generates a first stylized avatar of a person depicted in an input image using a first ML model trained on synthetic paired data, the first ML model mapping features of the input image to cartoon-style features while preserving identity characteristics of the person. The system processes, by a second ML model, the first stylized avatar together with the image depicting the person and a prompt to generate a dual-stylized avatar. The prompt comprising a description of a secondary style, the dual-stylized avatar comprising a second stylized avatar representing the first stylized avatar according to the secondary style of the description while maintaining the cartoon-style features. The system generates an animated 3D avatar from the dual-stylized avatar by applying a third ML model to the dual-stylized avatar that maps the dual-stylized avatar to a 3D face model.

### TECHNICAL FIELD

Examples of the present disclosure relate generally to a generating three-dimensional (3D) avatars. The 3D avatars can be generated and/or used on mobile devices, virtual reality (VR) environments, mixed reality (MR) environments, extended reality (XR) environments, and/or augmented reality (AR) environments.

### BACKGROUND

Three-dimensional (3D) avatars are digital representations of users that have become increasingly popular for online self-expression and personalized storytelling. Many platforms allow users to create stylized cartoon-like versions of themselves that can be used across various digital experiences. These avatar systems work by having users select from pre-defined traits like hairstyles, clothing, and facial features to customize their digital character.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates an example of a digital avatar creation system, according to some examples.

FIG. 2 illustrates example blendshapes for the digital avatar creation system, according to some examples.

FIG. 3 illustrates example inputs and outputs of the digital avatar creation system, according to some examples.

FIG. 4 illustrates a method performed by the digital avatar creation system, according to some examples.

FIG. 5 illustrates example inputs and outputs of the digital avatar creation system, according to some examples.

FIG. 6 illustrates a system in which the head-wearable apparatus can be implemented, according to some examples.

FIG. 7 is a diagrammatic representation of a machine in the form of a computer system within which a set of instructions may be executed to cause the machine to perform any one or more of the methodologies discussed herein, according to some examples.

FIG. 8 is a block diagram showing a software architecture within which examples may be implemented.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

3D avatars are digital representations that have become increasingly popular for online self-expression and personalized storytelling. Conventional avatar generation systems rely heavily on pre-defined assets created by artists, which severely restricts expressivity and customization. After a user creates their initial avatar, they cannot customize it in new styles (like “from the 1920s”), which is an expensive and time-consuming process. For example, certain platforms have over 150 avatar hairstyles that users must tediously select from. Current automated approaches that use classifiers to map photos to predefined avatar traits are inefficient because they require paired training data between real faces and avatar attributes, which is difficult to acquire at a large scale. While some systems attempt self-supervised training to address this, they can still only generate avatars from existing 3D assets rather than enabling truly flexible stylization.

Additionally, conventional systems sacrifice visual quality and detail to achieve efficient rendering, resulting in avatars with limited texture detail and polygon count. Methods that try to generate photorealistic avatars using 3D Morphable Models do not generalize well to cartoon-style avatars. Many existing systems that use generative adversarial networks (GANs) for stylization are extremely slow making them impractical for real-world applications. The appeal of 3D avatars lies in their ability to enable personalized storytelling. For example, users can place their avatars in different scenarios to create customized comics, games, videos and augmented reality experiences. However, current systems face significant technical limitations that prevent them from achieving the full potential of this technology.

The disclosed techniques address these and other challenges by providing a system that automatically generates a stylized and animatable avatar from an input image depicting a user's face very quickly, such as in only 2 seconds. Unlike conventional systems, the generated avatars are not limited to pre-defined assets, ensuring that the avatars faithfully embody the appearance and text description of style of users. The disclosed techniques introduce the novel concept of “dual stylization” which allows avatars to maintain a consistent primary cartoon style while adopting additional secondary styles, enabling users to reimagine their avatars in new scenarios without requiring pre-made assets. Specifically, the disclosed techniques introduce Gaussian Domain Adaptation (GDA), a novel method to map real photos to cartoon-style avatars while preserving identity characteristics, a diffusion-based pipeline that can customize avatars with new styles via simple text (or voice) prompts while maintaining the primary style, and a 3D generation approach that produces lightweight, animatable avatars represented by Gaussian Splats that can be rendered in real-time on mobile devices. Unlike conventional systems that rely on pre-defined assets or slow GAN-based approaches, the disclosed techniques require minimal or no manual customization, preserves user identity better than existing methods, and completes the entire avatar generation process faster than conventional solutions. The resulting avatars are both visually appealing and practical. They can take only a minimal amount of storage space while supporting real-time rendering (e.g., 30 frames-per-second (FPS)) for AR applications.

For example, the disclosed techniques can generate a first stylized avatar of a person depicted in an input image using a first machine learning (ML) model trained on synthetic paired data, the first ML model mapping features of the input image to cartoon-style features while preserving identity characteristics of the person. The disclosed techniques process, by a second ML model comprising a generative ML model, the first stylized avatar together with the image depicting the person and a prompt to generate a dual-stylized avatar; the prompt comprising a description of a secondary style, the dual-stylized avatar comprising a second stylized avatar representing the first stylized avatar according to the secondary style of the description while maintaining the cartoon-style features. The disclosed techniques generate an animated three-dimensional (3D) avatar from the dual-stylized avatar by applying a third ML model to the dual-stylized avatar that maps the dual-stylized avatar to a 3D face model.

In this way, the disclosed techniques can create virtual 3D avatars in a way that is free of the constraints mentioned above. The generated avatars embody users' likeness while enabling fast customization. The disclosed techniques improve the overall efficiencies of avatar systems by reducing the amount of data and computational resources needed to create and maintain such a system.

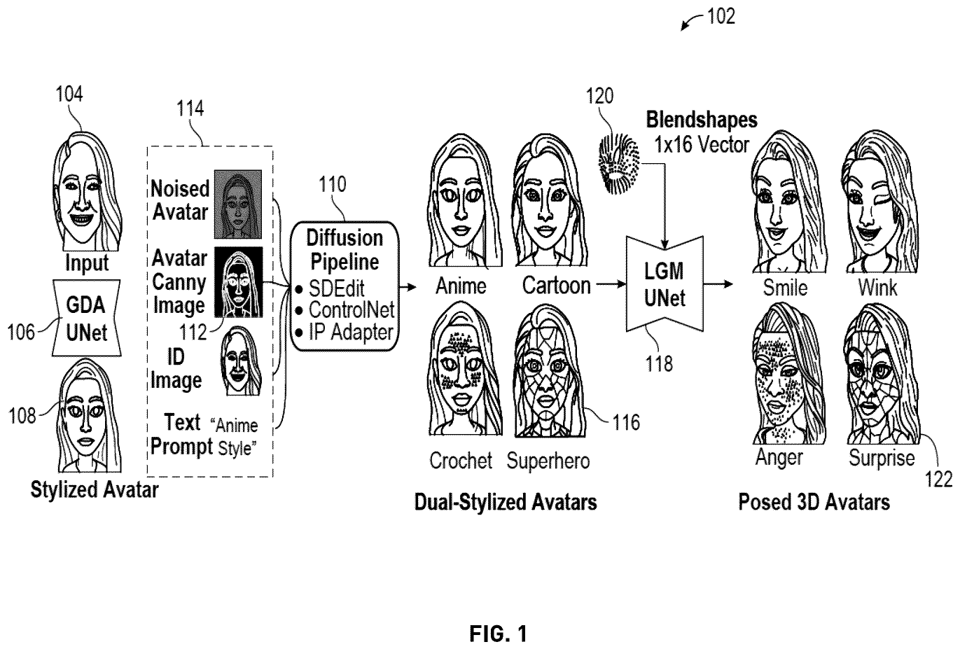

FIG. 1 illustrates an example of a digital avatar creation system 102, according to some examples. The digital avatar creation system 102 can include a GDA network 106, a diffusion network 110, a set of blendshape weights 120, and/or an LGM network 118.

The digital avatar creation system 102 can receive an input image 104 that depicts a person's face that will be transformed into a 3D stylized avatar. In some cases, the input image 104 is received by the digital avatar creation system 102 through a camera system of a mobile device capturing a real-time selfie image using a front-facing and/or rear-facing camera of a mobile device's camera hardware. The input image 104 can be received and/or accessed and/or selected from stored images retrieved from the memory of a user system (e.g., a mobile device), such as previously captured photos. In some cases, the input image 104 can be received via an interaction client receiving an uploaded image through a network from another user system and/or through the image processing system receiving image data from a digital effect system or digital effect creation system.

The input image 104 is provided as input to the GDA network 106 (e.g., a first ML model). The GDA network 106 can take the input image 104 and generate a first stylized avatar 108 in a first style (e.g., cartoon style) while preserving identity characteristics. The GDA network 106 preserves facial structure and proportions while generating the stylized avatar, maintaining key geometric features like the overall face shape, placement of eyes, nose, and mouth, and relative distances between facial features that make a person uniquely recognizable. This allows the generated avatar (e.g., the first stylized avatar 108) to maintain a clear visual connection to the original person's appearance in the input image 104 while adopting a cartoon aesthetic.

The digital avatar creation system 102 carefully preserves distinctive features like eye color, eyeglasses, facial hair, and unique hairstyles that are important aspects of a person's visual identity. For example, if the input image shows someone wearing sunglasses or having a beard, these defining characteristics are maintained in the stylized avatar rather than being generically smoothed away. The GDA network 106 can be specifically trained to maintain skin tone and general coloring that matches the input image while translating to the cartoon style. This helps ensure the avatar remains recognizable as representing the specific individual rather than producing a generic output. The GDA network 106 can preserve key facial expressions and emotional characteristics from the input image 104, maintaining the person's natural expression whether neutral, smiling, or showing other emotions. This helps capture not just physical features but also the personality and emotional qualities that make up someone's identity.

The GDA network 106 can maintain age-related characteristics and features that indicate generational identity, ensuring that the stylized avatar appropriately represents whether the input image shows a young person, middle-aged adult, or elderly individual. This preservation of age-appropriate features helps maintain the avatar's connection to the real person's identity across different life stages.

The GDA network 106 can be trained through a multi-step process that begins with generating synthetic paired training data. The training process of the GDA network 106 is specifically designed to preserve privacy by avoiding the use of any real user face data. The GDA network 106 generates synthetic training data by first taking a collection of cartoon avatar images and using a GAN to generate corresponding simulated realistic face images. This approach ensures that no actual human face photos are needed or used during the training process. The privacy-preserving aspects are further enhanced because the latent spaces of the source and target GANs are semantically aligned, allowing the system to learn the mapping between domains using only artificial data. The GAN inversion process generates paired training examples that maintain visual consistency while being completely synthetic.

The system's privacy-first design is reinforced by fine-tuning the GDA network 106 on this synthetic paired data rather than real user images. By starting with a model pre-trained on the Objaverse dataset of 3D objects and then fine-tuning only on synthetic faces, the GDA (Gaussian Domain Adaptation) network 106 develops robust avatar generation capabilities without ever requiring access to or storage of real user face data during the training phase. This synthetic data approach not only protects user privacy but also enables the system to learn generalizable features for translating between real and cartoon domains while maintaining complete separation from actual user biometric data during the training process. The training data generation pipeline ensures that even as the model learns to preserve identity characteristics, it does so without ever being trained on or storing real facial images.

The privacy protection extends to the deployment phase, where input images are processed to generate avatars without needing to store or retain the original photos. This end-to-end privacy-preserving design, built on synthetic training data, allows the system to generate high-quality personalized avatars while maintaining strong privacy guarantees around sensitive biometric information. For example, a GAN is first used to take cartoon avatar images as input and generate corresponding simulated realistic face images, since no large-scale dataset of real faces paired with cartoon avatars exists.

The GDA network 106 training can start with a model pre-trained on the Objaverse dataset to generate 3D objects from images. This provides the GDA network 106 with useful prior knowledge about image transformation. The GDA network 106 is then fine-tuned using the synthetic paired data to learn the mapping between realistic faces and cartoon avatars. Importantly, no real face images are used during this training process. The fine-tuning process takes place over multiple epochs, gradually shifting the model's output domain from realistic faces to cartoon avatars while preserving key identity features.

The synthetic training data generation can begin with a collection of cartoon avatar images (accessed from using an avatar generation engine (like Bitmoji) with random input parameters) that are inverted into a target GAN (G_{Tgt}) by a generative ML model to find their corresponding latent codes w. This inversion process is represented by the equation w:=argmin_{w∈W}∥G_{Tgt}(w)−I_{Tgt}|, where I_{Tgt} represents the target cartoon avatar image. The latent codes are then input into a source GAN (G_{Src}) by a generative ML model trained on real faces to generate simulated realistic face images I_{Src}=G_{Src}(w), creating synthetic paired training data without using any real user photos. For example, a first cartoon avatar image can be accessed and processed by the generative ML model to find the latent codes of the cartoon avatar image that are then used by another generative ML model to render a simulated realistic face having similar features as the avatar. This pair of images (cartoon image and simulated realistic face image) forms a first portion of the synthetic training data.

The GDA network 106 starts with a UNet model that was pre-trained on the Objaverse dataset to predict parameters of 3D Gaussians from input images. This provides the model with valuable prior knowledge about image transformation and 3D object generation that can be leveraged during fine-tuning. The pre-training on Objaverse gives the GDA network 106 a strong foundation for understanding geometric structures and visual features.

During fine-tuning, the GDA network 106 is trained using the synthetic paired data, with the simulated realistic images as input and the corresponding cartoon avatars as the target output. The training uses a combination of mean squared error (MSE) loss and perceptual LPIPS loss between the generated and target images:

$$L = {L}_{MSE} ( {I}_{Tgt} , {I}_{Tgt}^{Rendered} ) + {L}_{LPIPS} ( {I}_{Tgt} , {I}_{Tgt}^{Rendered} ) .$$

The network learns to output Gaussian parameters that, when rendered, produce cartoon-style images matching the target avatars.

The parameters of the GDA network 106 are updated through back-propagation to minimize these losses over multiple training epochs. As training progresses, the network gradually shifts its output domain from realistic faces to cartoon avatars while maintaining identity-preserving features. The use of both MSE and perceptual losses helps ensure the generated avatars capture both low-level pixel similarities and high-level perceptual features that make the cartoon recognizable as the input person.

For example, in a single training iteration, the GDA network 106 first receives a simulated realistic face image as input that was generated by the GAN. For example, if the GAN generated a simulated realistic face with brown hair and glasses, this would be provided to the GDA network 106. The GDA network 106 processes this input image through its UNet architecture to output Gaussian parameters that define position, color, density and orientation information. These parameters are then passed through a rendering function to generate a cartoon-style output image. The GDA network 106 compares this rendered cartoon output against the corresponding ground truth cartoon avatar from the synthetic paired training data using two loss functions: MSE loss that measures pixel-level differences between the rendered and target images and perceptual LPIPS loss that captures higher-level feature differences using deep network activations. The total loss

$$L = {L}_{MSE} ( {I}_{Tgt} , {I}_{Tgt}^{Rendered} ) + {L}_{LPIPS} ( {I}_{Tgt} , {I}_{Tgt}^{Rendered} )$$

is then used to update the GDA network 106 parameters through backpropagation. The gradients push the GDA network 106 to generate Gaussian parameters that, when rendered, produce cartoon avatars more closely matching the target style while preserving identity characteristics from the input face. For example, if the network's cartoon output failed to properly capture the glasses or hair color from the input face, the loss functions would generate gradients to adjust the GDA network 106 weights to better preserve these identifying features in the next iteration. This process repeats across many training examples, gradually improving the network's ability to transform realistic faces to cartoon avatars while maintaining identity.

The diffusion network 110 (e.g., a second ML model, such as a generative ML model) receives stylization data 114 as multiple inputs. The stylization data 114 can be received from the output of the GDA network 106 including the first stylized avatar 108. Namely, the stylization data 114 can include a noised avatar generated by adding random noise to the first stylized avatar 108, an avatar canny image showing edge detection of the first stylized avatar 108, the input image 104, and a text (and/or voice) prompt specifying the desired secondary style.

In some examples, the noised avatar can be generated by adding random noise to the first stylized avatar 108. This process involves taking the GDA-generated cartoon avatar and deliberately introducing random noise perturbations to its pixel values. The noise addition serves as part of the SDEdit component of the diffusion pipeline, allowing the model to better control the denoising process when generating the secondary style. The avatar canny image is generated by applying edge detection to the first stylized avatar 108 to create a map of its geometric structure. Specifically, the canny edge detection algorithm can be used to identify and extract the key edges and contours that define the avatar's features. This edge map is important for the ControlNet component to ensure the diffusion process preserves the original avatar's structural elements while applying the secondary style. Both the noised avatar and canny edge map are inputs that help guide the diffusion stylization process. Namely, the noised avatar provides a starting point for the denoising-based generation and the canny edge map ensures geometric consistency. Together with the original ID image (e.g., input image 104) and the text (and/or voice) prompt, they enable the diffusion network 110 to generate a second stylized avatar 116, or called a dual-stylized avatar, that maintains both identity and structural characteristics while adopting the desired secondary style.

The diffusion network 110 includes SDEdit which adds and denoises noise while being guided by the text prompt to customize features like art style. SDEdit is a Stochastic Differential Equation Edit, which is a technique that adds a small amount of random noise to an image and then denoises it while being guided by a text prompt to customize features. The technique uses stochastic differential equations during the denoising process to control how the image is transformed according to the prompt. The diffusion network 110 can also include ControlNet which uses the edge image to preserve geometric structure, and IP Adapter which maintains facial similarity. The diffusion network 110 uses a pre-trained Stable Diffusion model and can, for example, run only ten denoising steps with the DDIM scheduler to keep processing time short while still achieving good stylization results. The diffusion network 110 outputs a dual-stylized avatar including a second stylized avatar 116 that maintains the primary cartoon style while adopting secondary styles like “anime”, “cartoon”, or “crochet”, as specified by the text and/or voice prompts.

The text/voice prompts can be received through the interaction client via the user input components 726 of the I/O components 708, allowing users to directly input their desired secondary style descriptions through text entry or voice commands. For example, a user could type or speak prompts like “Generate my avatar in an Anime style” or “Make my avatar look like it's made of crochet yarn”. The prompts can also be received through a messaging system as part of interactions between user systems, enabling collaborative avatar stylization where users can suggest and share style prompts with each other. For instance, one user could send a message suggesting “Transform this avatar into an anime character style” which the system would then process as a style prompt. The digital avatar creation system 102 can provide predefined style prompt templates that content creators can customize and publish for users. These could include prompts like “Generate avatar as a plastic toy character” or “Create avatar in the style of an alien” that have been tested and optimized to produce consistent stylization results. The game system can also generate dynamic style prompts based on in-game contexts and events. For example, during Halloween-themed gameplay, the system could automatically apply prompts like “Transform avatar into a spooky skeleton style” or during sports games could generate prompts like “Style avatar as a player from team X.”

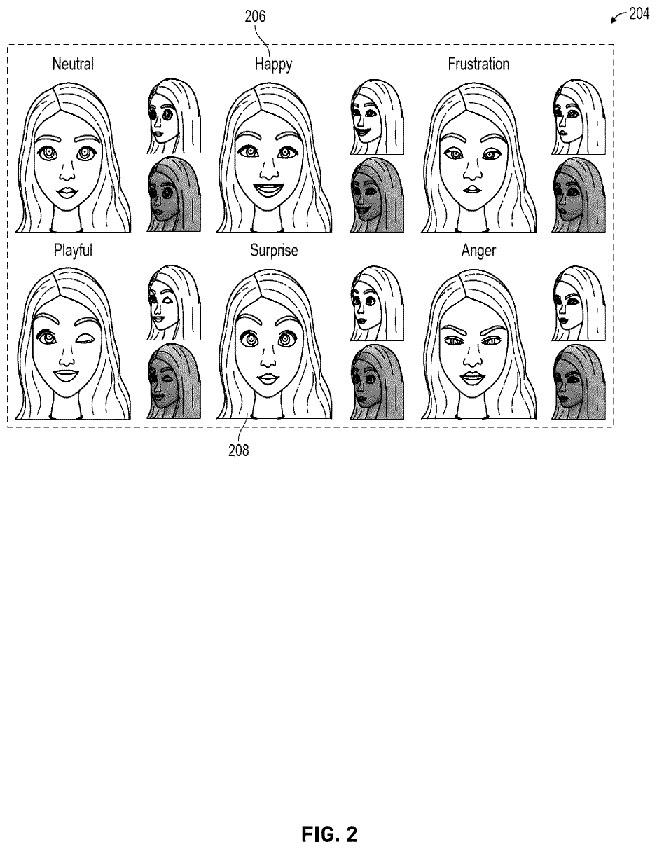

The output of the diffusion network 110 is then passed to the LGM (Large Multi-View Gaussian Model) network 118 (e.g., a third ML model). The LGM network 118 receives the dual-stylized avatar 116 and blendshape weights (e.g., set of blendshape weights 120) as input to generate a posed stylized avatar 122. The set of blendshape weights 120 can include a 1×16 vector that controls facial expressions and animations, corresponding to attributes from the Facial Action Coding System (FACS). As shown in FIG. 2, the blendshapes 204 can include a first set of blendshapes 206 and a second set of blendshapes 208 that control facial expressions and animations. The first set of blendshapes 206 demonstrates expressions including “Neutral,” “Happy,” and “Frustration,” while the second set of blendshapes 208 shows “Playful,” “Surprise,” and “Anger” expressions. These blendshapes can form a 1×16 vector that corresponds to attributes from the FACS to enable precise control over the avatar's emotional expressions and facial movements.

To train the LGM network 118, a dataset of 3D avatars can be used. Each avatar in the training set can be fully rigged and can be controlled with standard blendshapes. The training process involves rendering a front-facing view and, for example, ten other views from different angles around the head for each avatar. For each view, neutral poses and random expressions can be generated by sampling different blendshape weight combinations. The LGM network 118 can be trained to output many Gaussian parameters representing position, color, density, and/or orientation information that define the 3D avatar and its expression. These parameters can correspond to a 256×256 grid.

The LGM network 118 learns to generate these parameters from a single front-facing image while being conditioned on the blendshape weights through cross-attention on intermediate features. The LGM network 118 (e.g., the third ML model which can have similar architecture as the GDA network 106) can be modified to output flat 2D Gaussians and use the gsplat implementation of 2D Gaussian Splatting to achieve more detailed geometry suitable for animation and relighting. The LGM network 118 outputs the posed stylized avatar 122. The posed stylized avatar 122 can display different expressions like “Smile”, “Wink”, “Anger” and “Surprise” through the blendshape conditioning. The complete pipeline shown in digital avatar creation system 102 can transform a single input image into an animated 3D avatar very quickly, such as in approximately 2 seconds in total.

The resulting posed stylized avatar 122 can consume only 3 MB of disk space and can be rendered at 30 FPS on mobile devices, making them practical for real-world applications like AR. The system enables truly flexible stylization rather than being limited to existing 3D assets, while still maintaining efficient rendering and high visual quality.

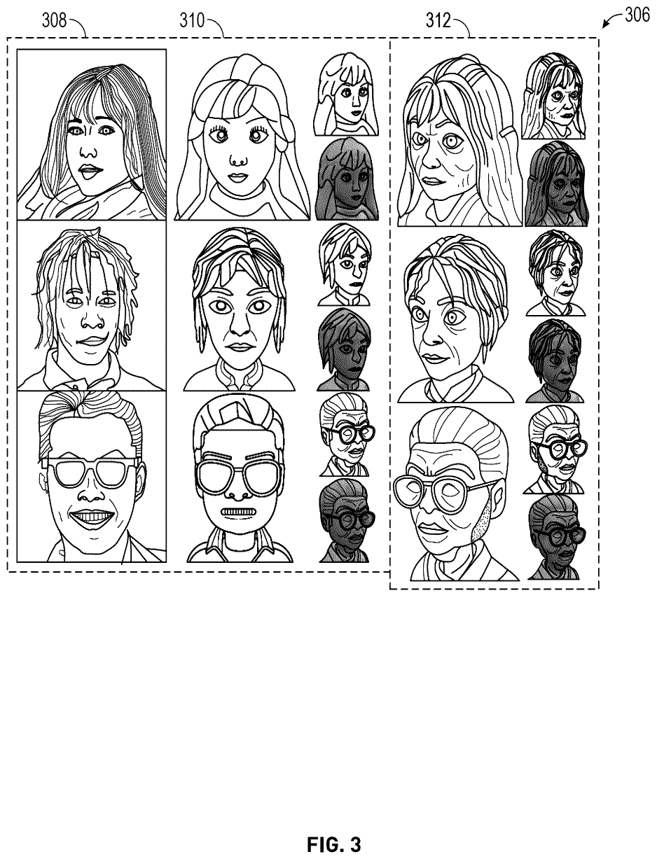

FIG. 3 illustrates example inputs and outputs of the digital avatar creation system 102, according to some examples. Specifically, FIG. 3 illustrates examples 306 of inputs and outputs of the digital avatar creation system 102, demonstrating the system's ability to preserve identity characteristics while generating stylized avatars.

FIG. 3 shows three columns of images (e.g., input image 308, first set of avatars 310, and second set of models 312), each demonstrating the progression from input photos to stylized avatars. The examples showcase how the system handles diverse input images with different facial features, accessories, and expressions.

For example, the first column shows three different input photographs including the input image 308. The input image 308 depicts a person wearing a yellow scarf, another in put image depicts a person with dreadlocks, and a third input image depicts a person wearing sunglasses. These input images represent the real photographs that users might provide as input to the system as input image 104.

The second column displays the stylized avatars generated by the digital avatar creation system 102 including the first set of avatars 310. The first set of avatars 310 show how the system preserves key identifying features like hairstyles, facial structure, and accessories while transforming the images into a cartoon style. The third column shows additional stylized versions of the avatars, demonstrating how the system can apply different artistic styles while maintaining the core identity features established in the second column.

The shaded normal maps shown alongside each stylized avatar demonstrate the system's ability to generate proper 3D geometry, which is important for creating animatable avatars that can be viewed from different angles.

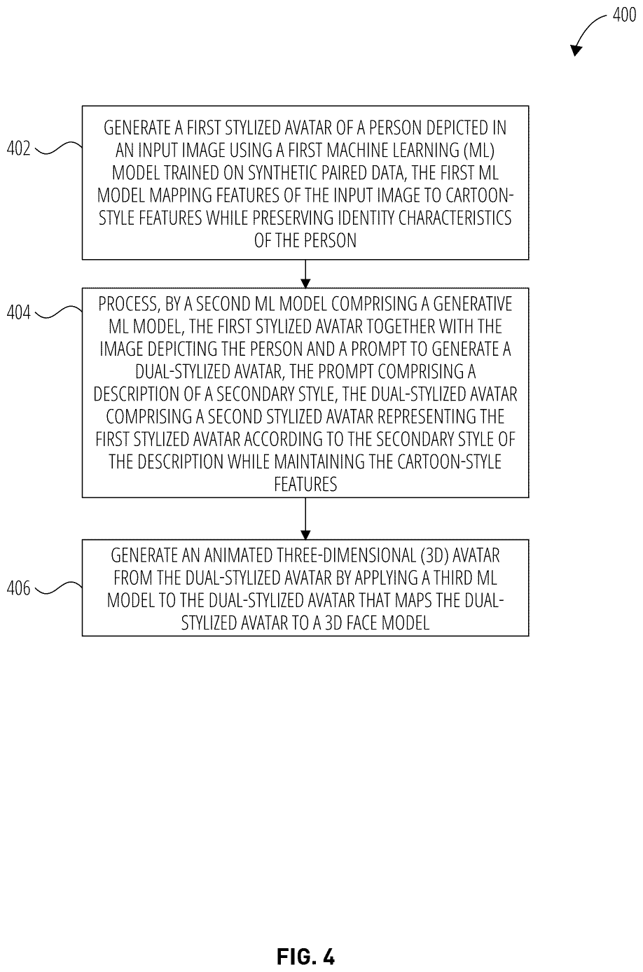

FIG. 4 illustrates a method 400 (routine and/or process) performed by the digital avatar creation system 102, in accordance with some examples. The method 400 may optionally include one or more additional operations. One or more of the operations of method 400 may be optional, e.g., 402 is not needed if the user already has an avatar.

The method 400 can perform various operations. At operation 402, the digital avatar creation system 102 generates a first stylized avatar of a person depicted in an input image using a first ML model trained on synthetic paired data. The first ML model maps features of the input image to cartoon-style features while preserving identity characteristics of the person, such as facial structure, eye color, hairstyle, and other distinctive features.

At operation 404, the digital avatar creation system 102 processes, using a second ML model including a generative ML model, the first stylized avatar together with the image depicting the person and a prompt to generate a dual-stylized avatar. The prompt comprises a description of a secondary style, such as “cartoon style” or “as a plastic toy”. The dual-stylized avatar including a second stylized avatar represents the first stylized avatar according to the secondary style of the description while maintaining the cartoon-style features. This operation uses a diffusion pipeline that includes SDEdit for noise addition and denoising, ControlNet for preserving geometric structure, and IP Adapter for maintaining facial similarity.

At operation 406, the digital avatar creation system 102 generates an animated 3D avatar from the dual-stylized avatar by applying a third ML model to the dual-stylized avatar that maps the dual-stylized avatar to a 3D face model. This operation can use an LGM UNet conditioned on facial blendshape weights to generate and animate the 3D avatar. The resulting 3D avatar can display different expressions like “Smile”, “Wink”, “Anger” and “Surprise” through the blendshape conditioning while maintaining the stylistic features from both the primary cartoon style and secondary style.

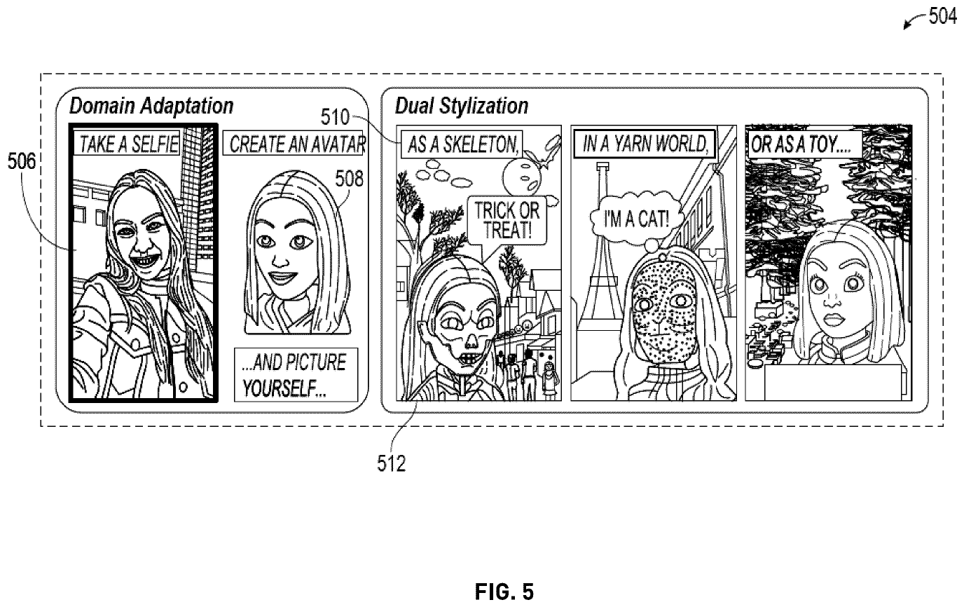

FIG. 5 illustrates example inputs and outputs of the digital avatar creation system 102, according to some examples. Specifically, FIG. 5 illustrates diagram 504 showing examples of domain adaptation and dual stylization capabilities of the digital avatar creation system 102.

The diagram 504 includes an input image 506 showing a selfie photograph taken by a user, demonstrating the starting point for the avatar creation process. Next to the input image 506, the system shows the domain adaptation process where the GDA network 106 generates an avatar in first style 508, such as in the primary cartoon style while preserving key identity characteristics of the person.

The diagram 504 then demonstrates the dual stylization capabilities through three different examples labeled “AS A TOY”, “IN A YARN WORLD”, and “AS A SKELETON”, showing how the diffusion network 110 can apply different secondary styles while maintaining the primary cartoon aesthetic. Each stylized example includes a text prompt 510 that specifies the desired secondary style, such as transforming the avatar into a toy character or yarn creation.

The resulting avatar in second style 512 shows how the system can maintain consistent identity features while adopting dramatically different artistic styles as specified by the text prompts. The progression from input photo to stylized avatars demonstrates how the system preserves important identifying characteristics while enabling creative transformations through the dual stylization process.

Speech bubbles and thought bubbles are included to show how the avatars can be used in interactive scenarios, with examples like “TRICK OR TREAT!” and “I'M A CAT!” demonstrating potential applications in personalized comics and storytelling. The background environments in each stylized example are tailored to match the secondary style, showing how the system considers the overall aesthetic context when applying stylization.

The avatar in second style 512 can be placed in AR environments through a head-wearable apparatus and its associated components. The image display of optical assembly 618 can present the avatar in real-time AR environments, while an image display driver 620 and image processor 622 handle the rendering and positioning of the avatar. The digital avatar creation system 102 enables real-time animation of the avatar through facial tracking using an infrared emitter 608 and infrared camera 610, which track the user's facial movements to automatically select appropriate blendshape weights for controlling the avatar's expressions. A visible light camera 606 can also capture the real-world environment to enable proper placement and interaction of the avatar.

A high-speed processor 630 and high-speed circuitry 626 enable rendering of the avatar at 30 frames-per-second on mobile devices, making it suitable for real-time AR applications. The avatar can require only 3 MB of storage space in memory 602, making it efficient for mobile AR use. As shown in FIG. 5, this allows the avatar to be placed in themed AR environments matching its secondary style, such as a spooky nighttime scene for a Halloween-themed avatar or a toy-style environment for a toy-themed avatar.

The system supports real-time facial animation through the blendshapes shown in FIG. 2, allowing the avatar to display expressions like “Neutral”, “Happy”, “Frustration”, “Playful”, “Surprise” and “Anger” in response to the user's actual facial movements while in AR. This enables natural interaction and emotional expression when using the avatar in AR environments.

System with Head-Wearable Apparatus

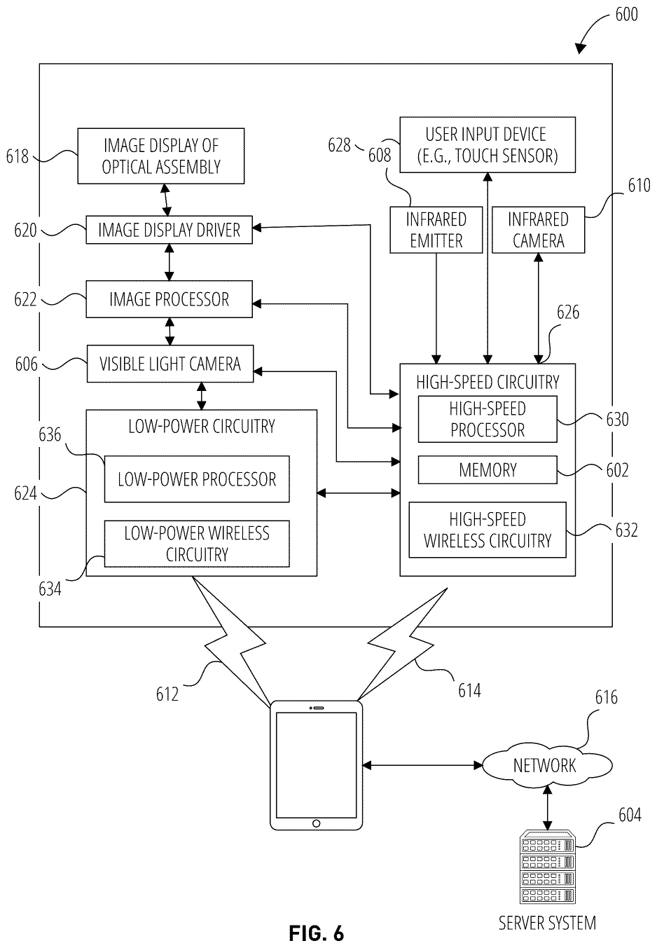

FIG. 6 illustrates a system 600 including a head-wearable apparatus 116 with a selector input device, according to some examples that can be used to implement the digital avatar creation system 102. FIG. 6 is a high-level functional block diagram of an example head-wearable apparatus 116 communicatively coupled to a mobile device 114 and various server systems 604 (e.g., the server system 110) via various networks 108.

The head-wearable apparatus 116 includes one or more cameras, each of which may be, for example, a visible light camera 606, an infrared emitter 608, and an infrared camera 610. In some cases, the head-wearable apparatus 116 includes a digital effect display component including the image display of optical assembly 618 or other digital effect presentation systems.

The mobile device 114 connects with head-wearable apparatus 116 using both a low-power wireless connection 612 and a high-speed wireless connection 614. The mobile device 114 is also connected to the server system 604 and the Network 616.

The head-wearable apparatus 116 further includes two image displays of the image display of optical assembly 618. The two image displays of optical assembly 618 include one associated with the left lateral side and one associated with the right lateral side of the head-wearable apparatus 116. The head-wearable apparatus 116 also includes an image display driver 620, an image processor 622, low-power circuitry 624, and high-speed circuitry 626. The image display of optical assembly 618 is for presenting images and videos, including an image that can include a graphical user interface to a user of the head-wearable apparatus 116.

The image display driver 620 commands and controls the image display of optical assembly 618. The image display driver 620 may deliver image data directly to the image display of optical assembly 618 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 628 (e.g., touch sensor or push button), including an input surface on the head-wearable apparatus 116. The user input device 628 (e.g., touch sensor or push button) is to receive from the user an input selection to manipulate the graphical user interface of the presented image.

The components shown in FIG. 6 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 606 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 602, which stores instructions to perform a subset, or all the functions described herein. The memory 602 can also include storage device.

As shown in FIG. 6, the high-speed circuitry 626 includes a high-speed processor 630, a memory 602, and high-speed wireless circuitry 632. In some examples, the image display driver 620 is coupled to the high-speed circuitry 626 and operated by the high-speed processor 630 to drive the left and right image displays of the image display of optical assembly 618. The high-speed processor 630 may be any processor capable of managing high-speed communications and operation of any general computing system needed for the head-wearable apparatus 116. The high-speed processor 630 includes processing resources needed for managing high-speed data transfers on a high-speed wireless connection 614 to a wireless local area network (WLAN) using the high-speed wireless circuitry 632. In certain examples, the high-speed processor 630 executes an operating system such as a LINUX operating system or other such operating system of the head-wearable apparatus 116, and the operating system is stored in the memory 602 for execution. In addition to any other responsibilities, the high-speed processor 630 executing a software architecture for the head-wearable apparatus 116 is used to manage data transfers with high-speed wireless circuitry 632. In certain examples, the high-speed wireless circuitry 632 is configured to implement Institute of Electrical and Electronic Engineers (IEEE) 802.11 communication standards, also referred to herein as WI-FIR. In some examples, other high-speed communications standards may be implemented by the high-speed wireless circuitry 632.

The low-power wireless circuitry 634 and the high-speed wireless circuitry 632 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 612 and the high-speed wireless connection 614, may be implemented using details of the architecture of the head-wearable apparatus 116, as can other elements of the Network 616.

The memory 602 includes any storage device capable of storing various data and applications, including, among other things, camera data generated by the left and right visible light cameras 606, the infrared camera 610, and the image processor 622, as well as images generated for display by the image display driver 620 on the image displays of the image display of optical assembly 618. While the memory 602 is shown as integrated with high-speed circuitry 626, in some examples, the memory 602 may be an independent standalone element of the head-wearable apparatus 116. In certain such examples, electrical routing lines may provide a connection through a chip that includes the high-speed processor 630 from the image processor 622 or the low-power processor 636 to the memory 602. In some examples, the high-speed processor 630 may manage addressing of the memory 602 such that the low-power processor 636 will boot the high-speed processor 630 any time that a read or write operation involving memory 602 is needed.

As shown in FIG. 6, the low-power processor 636 or high-speed processor 630 of the head-wearable apparatus 116 can be coupled to the camera (visible light camera 606, infrared emitter 608, or infrared camera 610), the image display driver 620, the user input device 628 (e.g., touch sensor or push button), and the memory 602.

The head-wearable apparatus 116 is connected to a host computer. For example, the head-wearable apparatus 116 is paired with the mobile device 114 via the high-speed wireless connection 614 or connected to the server system 604 via the Network 616. The server system 604 may be one or more computing devices as part of a service or network computing system, for example, that includes a processor, a memory, and network communication interface to communicate over the Network 616 with the mobile device 114 and the head-wearable apparatus 116.

The mobile device 114 includes a processor and a network communication interface coupled to the processor. The network communication interface allows for communication over the network 616, low-power wireless connection 612, or high-speed wireless connection 614. Mobile device 114 can further store at least portions of the instructions in the memory of the mobile device 114 memory to implement the functionality described herein.

Output components of the head-wearable apparatus 116 include visual components, such as a liquid crystal display (LCD), a plasma display panel (PDP), a light-emitting diode (LED) display, a projector, or a waveguide. The image displays of the optical assembly are driven by the image display driver 620. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 604, such as the user input device 628, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 612 and high-speed wireless connection 614 from the mobile device 114 via the low-power wireless circuitry 634 or high-speed wireless circuitry 632.

### Machine Architecture

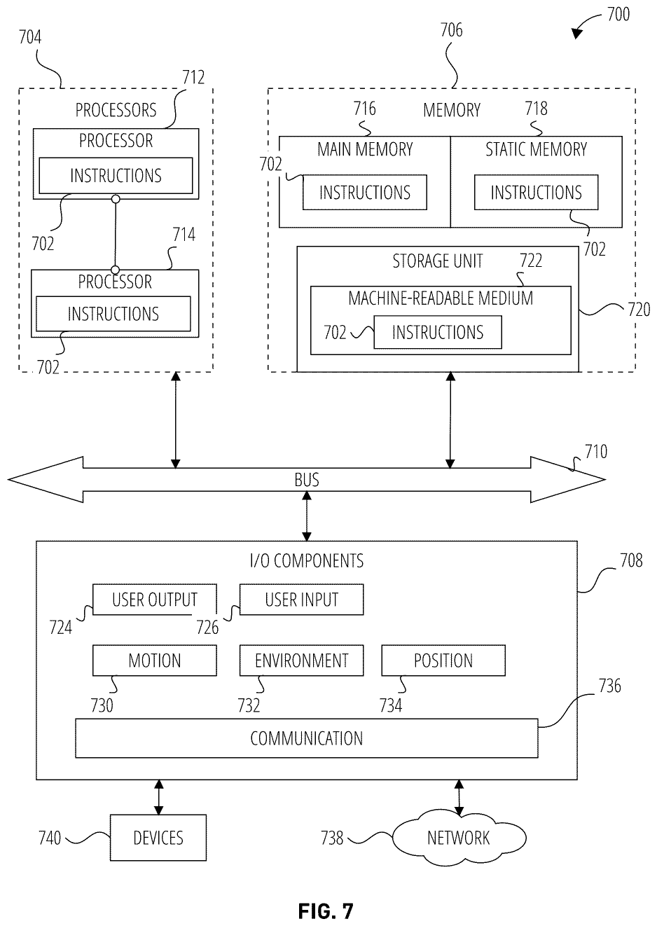

FIG. 7 is a diagrammatic representation of the machine 700 within which instructions 702 (e.g., software, a program, an application, an applet, an app, or other executable code) for causing the machine 700 to perform any one or more of the methodologies discussed herein may be executed including the digital avatar creation system 102. For example, the instructions 702 may cause the machine 700 to execute any one or more of the methods described herein. The instructions 702 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 702, sequentially or otherwise, that specify actions to be taken by the machine 700. Further, while a single machine 700 is illustrated, the term “machine” shall also be taken to include a collection of machines that individually or jointly execute the instructions 702 to perform any one or more of the methodologies discussed herein. The machine 700, for example, may comprise the user system 102 or any one of multiple server devices forming part of the server system 110. In some examples, the machine 700 may also comprise both client and server systems, with certain operations of a particular method or algorithm being performed on the server-side and with certain operations of the method or algorithm being performed on the client-side.

The machine 700 may include processors 704, memory 706, and input/output I/O components 708, which may be configured to communicate with each other via a bus 710.

The memory 706 includes a main memory 716, a static memory 718, and a storage unit 720, both accessible to the processors 704 via the bus 710. The main memory 706, the static memory 718, and storage unit 720 store the instructions 702 embodying any one or more of the methodologies or functions described herein. The instructions 702 may also reside, completely or partially, within the main memory 716, within the static memory 718, within machine-readable medium 722 within the storage unit 720, within at least one of the processors 704 (e.g., within the processor's cache memory), or any suitable combination thereof, during execution thereof by the machine 700.

The I/O components 708 may include a wide variety of components to receive input, provide output, produce output, transmit information, exchange information, capture measurements, and so on. The specific I/O components 708 that are included in a particular machine will depend on the type of machine. For example, portable machines such as mobile phones may include a touch input device or other such input mechanisms, while a headless server machine will likely not include such a touch input device. It will be appreciated that the I/O components 708 may include many other components that are not shown in FIG. 7. In various examples, the I/O components 708 may include user output components 724, position components 734, and user input components 726. The user output components 724 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 730 include acceleration sensor components (e.g., accelerometer), gravitation sensor components, and rotation sensor components (e.g., gyroscope).

The environmental components 732 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, a user system may have a camera system comprising, for example, front cameras on a front surface of the user system and rear cameras on a rear surface of the user system. The front cameras may, for example, be used to capture still images and video of a user of the user system (e.g., “selfies”), which may then be modified with digital effect data (e.g., avatars) described above. The rear cameras may, for example, be used to capture still images and videos in a more traditional camera mode, with these images similarly being modified with digital effect data. In addition to front and rear cameras, the user system may also include a 360° camera for capturing 360° photographs and videos.

Moreover, the camera system of the user system may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system may also feature triple, quad, or even penta camera configurations on both the front and rear sides of the user system. These multiple cameras systems may include a wide camera, an ultra-wide camera, a telephoto camera, a macro camera, and a depth sensor, for example.

Communication may be implemented using a wide variety of technologies. The I/O components 708 further include communication components 736 operable to couple the machine 700 to a network 738 or devices 740 via respective coupling or connections. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 740 may be another machine or any of a wide variety of peripheral devices (e.g., a peripheral device coupled via a USB).

Moreover, the communication components 736 may detect identifiers or include components operable to detect identifiers. For example, the communication components 736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 736, such as location via Internet Protocol (IP) geolocation, location via Wi-Fi® signal triangulation, location via detecting an NFC beacon signal that may indicate a particular location, and so forth.

The various memories (e.g., main memory 716, static memory 718, and memory of the processors 704) and storage unit 720 may store one or more sets of instructions and data structures (e.g., software) embodying or used by any one or more of the methodologies or functions described herein. These instructions (e.g., the instructions 702), when executed by processors 704, cause various operations to implement the disclosed examples.

The instructions 702 may be transmitted or received over the network 738, using a transmission medium, via a network interface device (e.g., a network interface component included in the communication components 736) and using any one of several well-known transfer protocols (e.g., hypertext transfer protocol (HTTP)). Similarly, the instructions 702 may be transmitted or received using a transmission medium via a coupling (e.g., a peer-to-peer coupling) to the devices 740.

### Software Architecture

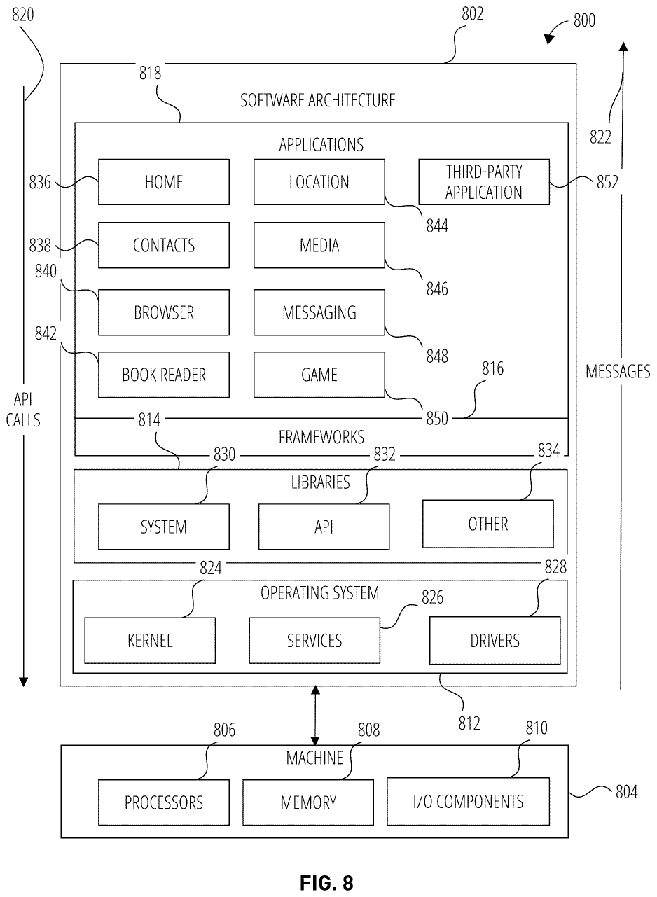

FIG. 8 is a block diagram 800 illustrating a software architecture 802, which can be installed on any one or more of the devices described herein. The software architecture 802 is supported by hardware such as a machine 804 that includes Processors 806, memory 808, and I/O components 810. In this example, the software architecture 802 can be conceptualized as a stack of layers, where each layer provides a particular functionality. The software architecture 802 includes layers such as an operating system 812, libraries 814, frameworks 816, and applications 818. Operationally, the applications 818 invoke API calls 820 through the software stack and receive messages 822 in response to the API calls 820.

The operating system 812 manages hardware resources and provides common services. The operating system 812 includes, for example, a kernel 824, services 826, and drivers 828. The kernel 824 acts as an abstraction layer between the hardware and the other software layers. For example, the kernel 824 provides memory management, processor management (e.g., scheduling), component management, networking, and security settings, among other functionalities. The services 826 can provide other common services for the other software layers. The drivers 828 are responsible for controlling or interfacing with the underlying hardware. For instance, the drivers 828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 814 provide a common low-level infrastructure used by the applications 818. The libraries 814 can include system libraries 830 (e.g., C standard library) that provide functions such as memory allocation functions, string manipulation functions, mathematical functions, and the like. In addition, the libraries 814 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 814 can also include a wide variety of other libraries 834 to provide many other APIs to the applications 818.

The frameworks 816 provide a common high-level infrastructure that is used by the applications 818. For example, the frameworks 816 provide various graphical user interface (GUI) functions, high-level resource management, and high-level location services. The frameworks 816 can provide a broad spectrum of other APIs that can be used by the applications 818, some of which may be specific to a particular operating system or platform.

In an example, the applications 818 may include a home application 836, a contacts application 838, a browser application 840, a book reader application 842, a location application 844, a media application 846, a messaging application 848, a game application 850, and a broad assortment of other applications such as a third-party application 852. The applications 818 are programs that execute functions defined in the programs. Various programming languages can be employed to create one or more of the applications 818, structured in a variety of manners, such as object-oriented programming languages (e.g., Objective-C, Java, or C++) or procedural programming languages (e.g., C or assembly language). In a specific example, the third-party application 852 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 852 can invoke the API calls 820 provided by the operating system 812 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The term mobile device is used as an illustrative device; however, one skilled in the art will recognize that the methods, systems, and computer readable medium disclosed herein are applicable to other mobile devices such as wearable devices or non-wearable devices including AR, VR and MR head-wearable devices (also referred to as digital effect creation and/or presentation applications, devices and/or systems).

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

### EXAMPLE STATEMENTS

Example 1. A system comprising: at least one processor; at least one memory component storing instructions that, when executed by the at least one processor, cause the at least one processor to perform operations comprising: generating a first stylized avatar of a person depicted in an input image using a first machine learning (ML) model trained on synthetic paired data, the first ML model mapping features of the input image to cartoon-style features while preserving identity characteristics of the person; processing, by a second ML model comprising a generative ML model, the first stylized avatar together with the image depicting the person and a prompt to generate a dual-stylized avatar, the prompt comprising a description of a secondary style, the dual-stylized avatar comprising a second stylized avatar representing the first stylized avatar according to the secondary style of the description while maintaining the cartoon-style features; and generating an animated three-dimensional (3D) avatar from the dual-stylized avatar by applying a third ML model to the dual-stylized avatar that maps the dual-stylized avatar to a 3D face model.

Example 2. The system of Example 1, the operations comprising: receiving a two-dimensional (2D) image depicting the person as the input image.

Example 3. The system of any one of Examples 1-2, wherein the first ML model comprises a Gaussian Domain Adaptation (GDA) model, wherein the generative ML model comprises a diffusion model, and wherein the prompt is a text prompt.

Example 4. The system of Example 3, wherein the diffusion model is conditioned using: a ControlNet model trained on edge maps to guide geometric structure; and an IP Adapter model trained on facial similarity embeddings to preserve identity.

Example 5. The system of any one of Examples 3-4, wherein the third ML model comprises a Large Gaussian Model (LGM) neural network.

Example 6. The system of Example 5, wherein the third ML model comprises a UNet that maps the dual-stylized avatar to 3D Gaussian parameters, and wherein the 3D Gaussian parameters comprise position, color, density, or orientation parameters.

Example 7. The system of any one of Examples 5-6, the operations comprising: selecting one or more facial blendshape weights; and modifying, by the LGM neural network, an expression of the 3D avatar based on the one or more facial blendshape weights.

Example 8. The system of any one of Examples 1-7, wherein the operations for generating the animated 3D avatar comprise: receiving facial blendshape weights corresponding to different facial expressions; and conditioning the third ML model on the facial blendshape weights to generate different expressions for the 3D avatar.

Example 9. The system of Example 8, wherein the facial blendshape weights control attributes comprising eye position and mouth shape.

Example 10. The system of any one of Examples 8-9, wherein the facial blendshape weights are determined based on facial tracking of the person in the image.

Example 11. The system of any one of Examples 1-10, wherein the synthetic paired data is generated by performing operations comprising: receiving a set of cartoon avatar images; applying a generative adversarial network (GAN) inversion to the set of cartoon avatar images to generate simulated real person images corresponding to the cartoon avatar images; and using the cartoon avatar images and corresponding simulated real person images as training data for the first ML model.

Example 12. The system of Example 11, wherein the first ML model is fine-tuned based on the synthetic paired data from a pre-trained model initially trained on a dataset of 3D objects.

Example 13. The system of any one of Examples 1-12, wherein the first ML model is trained by performing training operations comprising: receiving a set of cartoon avatar images; inverting the cartoon avatar images into a target generative adversarial network (GAN) to find latent codes; and inputting the latent codes into a source GAN to generate simulated real person images corresponding to the cartoon avatar images; fine-tuning a pre-trained GDA UNet model using the synthetic paired data by: providing one of the simulated real person images as input to the UNet model; generating a rendered image by applying a rendering function to Gaussian parameters output by the UNet model, and updating parameters of the UNet model based on a loss function that computes a deviation between the rendered image and the corresponding cartoon avatar image in the synthetic paired data, the loss function comprising a mean squared error loss and a perceptual loss.

Example 14. The system of Example 13, wherein: the target GAN is fine-tuned on the set of cartoon avatar images from a pre-trained GAN trained on real faces; and latent spaces of the source GAN and target GAN are semantically aligned such that a latent code corresponds to a same identity in both domains but with different styles.

Example 15. The system of any one of Examples 13-14, wherein: the pre-trained GDA UNet model is initially trained on a dataset of three-dimensional objects to predict parameters of three-dimensional Gaussians from input images; and the fine-tuning repurposes the pre-trained UNet model for two-dimensional image translation while leveraging prior knowledge from the initial training.

Example 16. The system of any one of Examples 1-15, the operations comprising: adding noise to the first stylized avatar to generate a noised avatar; generating an edge map of the first stylized avatar; and providing the noised avatar, edge map, image depicting the person, and prompt to the generative ML model.

Example 17. The system of any one of Examples 1-16, wherein the second ML model is trained on a dataset of 3D cartoon avatars rendered from multiple viewpoints, and wherein each cartoon avatar in the training dataset is rendered from a front-facing view and multiple views spherically distributed around a head, wherein the training dataset includes cartoon avatars with neutral poses and randomly sampled facial expressions.

Example 18. The system of any one of Examples 1-17, the operations comprising: placing the 3D avatar in an augmented reality (AR) experience comprising one or more digital effects.

Example 19. A method comprising: generating a first stylized avatar of a person depicted in an input image using a first machine learning (ML) model trained on synthetic paired data, the first ML model mapping features of the input image to cartoon-style features while preserving identity characteristics of the person; processing, by a second ML model comprising a generative ML model, the first stylized avatar together with the image depicting the person and a prompt to generate a dual-stylized avatar, the prompt comprising a description of a secondary style, the dual-stylized avatar comprising a second stylized avatar representing the first stylized avatar according to the secondary style of the description while maintaining the cartoon-style features; and generating an animated three-dimensional (3D) avatar from the dual-stylized avatar by applying a third ML model to the dual-stylized avatar that maps the dual-stylized avatar to a 3D face model.

Example 20. A non-transitory computer-readable storage medium storing instructions that, when executed by at least one processor, cause the at least one processor to perform operations comprising: generating a first stylized avatar of a person depicted in an input image using a first machine learning (ML) model trained on synthetic paired data, the first ML model mapping features of the input image to cartoon-style features while preserving identity characteristics of the person; processing, by a second ML model comprising a generative ML model, the first stylized avatar together with the image depicting the person and a prompt to generate a dual-stylized avatar, the prompt comprising a description of a secondary style, the dual-stylized avatar comprising a second stylized avatar representing the first stylized avatar according to the secondary style of the description while maintaining the cartoon-style features; and generating an animated three-dimensional (3D) avatar from the dual-stylized avatar by applying a third ML model to the dual-stylized avatar that maps the dual-stylized avatar to a 3D face model.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5GTM network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor; and
at least one memory component storing instructions that, when executed by the at least one processor, cause the at least one processor to perform operations comprising:
generating a first stylized avatar of a person depicted in an input image using a first machine learning (ML) model trained on synthetic paired data, the first ML model mapping features of the input image to cartoon-style features while preserving identity characteristics of the person;
processing, by a second ML model comprising a generative ML model, the first stylized avatar together with the image depicting the person and a prompt to generate a dual-stylized avatar, the prompt comprising a description of a secondary style, the dual-stylized avatar comprising a second stylized avatar representing the first stylized avatar according to the secondary style of the description while maintaining the cartoon-style features; and
generating an animated three-dimensional (3D) avatar from the dual-stylized avatar by applying a third ML model to the dual-stylized avatar that maps the dual-stylized avatar to a 3D face model.

2. The system of claim 1, the operations comprising:
receiving a two-dimensional (2D) image depicting the person as the input image.

3. The system of claim 1, wherein the first ML model comprises a Gaussian Domain Adaptation (GDA) model, wherein the generative ML model comprises a diffusion model, and wherein the prompt is a text prompt.

4. The system of claim 3, wherein the diffusion model is conditioned using:
a ControlNet model trained on edge maps to guide geometric structure; and
an IP Adapter model trained on facial similarity embeddings to preserve identity.

5. The system of claim 3, wherein the third ML model comprises a Large Gaussian Model (LGM) neural network.

6. The system of claim 5, wherein the third ML model comprises a UNet that maps the dual-stylized avatar to 3D Gaussian parameters, and wherein the 3D Gaussian parameters comprise position, color, density, or orientation parameters.

7. The system of claim 5, the operations comprising:
selecting one or more facial blendshape weights; and
modifying, by the LGM neural network, an expression of the 3D avatar based on the one or more facial blendshape weights.

8. The system of claim 1, wherein the operations for generating the animated 3D avatar comprise:
receiving facial blendshape weights corresponding to different facial expressions; and
conditioning the third ML model on the facial blendshape weights to generate different expressions for the 3D avatar.

9. The system of claim 8, wherein the facial blendshape weights control attributes comprising eye position and mouth shape.

10. The system of claim 8, wherein the facial blendshape weights are determined based on facial tracking of the person in the image.

11. The system of claim 1, wherein the synthetic paired data is generated by performing operations comprising:
receiving a set of cartoon avatar images;
applying a generative adversarial network (GAN) to the set of cartoon avatar images to generate simulated real person images corresponding to the cartoon avatar images; and
using the cartoon avatar images and corresponding simulated real person images as training data for the first ML model.

12. The system of claim 11, wherein the first ML model is fine-tuned based on the synthetic paired data from a pre-trained model initially trained on a dataset of 3D objects.

13. The system of claim 1, wherein the first ML model is trained by performing training operations comprising:
receiving a set of cartoon avatar images;
inverting the cartoon avatar images into a target generative adversarial network (GAN) to find latent codes;
inputting the latent codes into a source GAN to generate simulated real person images corresponding to the cartoon avatar images; and
fine-tuning a pre-trained UNet model using the synthetic paired data by:
providing one of the simulated real person images as input to the UNet model;
generating a rendered image by applying a rendering function to Gaussian parameters output by the UNet model, and
updating parameters of the UNet model based on a loss function that computes a deviation between the rendered image and the corresponding cartoon avatar image in the synthetic paired data, the loss function comprising a mean squared error loss and a perceptual loss.

14. The system of claim 13, wherein:
the target GAN is fine-tuned on the set of cartoon avatar images from a pre-trained GAN trained on real faces; and
latent spaces of the source GAN and target GAN are semantically aligned such that a latent code corresponds to a same identity in both domains but with different styles.

15. The system of claim 13, wherein:
the pre-trained UNet model is initially trained on a dataset of three-dimensional objects to predict parameters of three-dimensional Gaussians from input images; and
the fine-tuning repurposes the pre-trained UNet model for two-dimensional image translation while leveraging prior knowledge from the initial training.

16. The system of claim 1, the operations comprising:
adding noise to the first stylized avatar to generate a noised avatar;
generating an edge map of the first stylized avatar; and
providing the noised avatar, edge map, image depicting the person, and prompt to the generative ML model.

17. The system of claim 1, wherein the third ML model is trained on a dataset of 3D cartoon avatars rendered from multiple viewpoints, and wherein each cartoon avatar in the training dataset is rendered from a front-facing view and multiple views spherically distributed around a head, wherein the training dataset includes cartoon avatars with neutral poses and randomly sampled facial expressions.

18. The system of claim 1, the operations comprising:
placing the 3D avatar in an augmented reality (AR) experience comprising one or more digital effects.

19. A method comprising:
generating a first stylized avatar of a person depicted in an input image using a first machine learning (ML) model trained on synthetic paired data, the first ML model mapping features of the input image to cartoon-style features while preserving identity characteristics of the person;
processing, by a second ML model comprising a generative ML model, the first stylized avatar together with the image depicting the person and a prompt to generate a dual-stylized avatar, the prompt comprising a description of a secondary style, the dual-stylized avatar comprising a second stylized avatar representing the first stylized avatar according to the secondary style of the description while maintaining the cartoon-style features; and
generating an animated three-dimensional (3D) avatar from the dual-stylized avatar by applying a third ML model to the dual-stylized avatar that maps the dual-stylized avatar to a 3D face model.

20. A non-transitory computer-readable storage medium storing instructions that, when executed by at least one processor, cause the at least one processor to perform operations comprising:
generating a first stylized avatar of a person depicted in an input image using a first machine learning (ML) model trained on synthetic paired data, the first ML model mapping features of the input image to cartoon-style features while preserving identity characteristics of the person;
processing, by a second ML model comprising a generative ML model, the first stylized avatar together with the image depicting the person and a prompt to generate a dual-stylized avatar, the prompt comprising a description of a secondary style, the dual-stylized avatar comprising a second stylized avatar representing the first stylized avatar according to the secondary style of the description while maintaining the cartoon-style features; and
generating an animated three-dimensional (3D) avatar from the dual-stylized avatar by applying a third ML model to the dual-stylized avatar that maps the dual-stylized avatar to a 3D face model.
